(19) United States
(12) Patent Application Publication
(10) Pub. No.: US 2023/0269110 A1
(43) Pub. Date: Aug. 24, 2023

(54) SYSTEMS AND METHODS FOR KEEP-ALIVE ACTIVITIES

(71) Applicant: ARRIS Enterprises LLC, Suwanee, GA (US)

(72) Inventor: Thomas J. CLOONAN, Lisle, IL (US)

(73) Assignee: ARRIS Enterprises LLC, Suwanee, GA (US)

(21) Appl. No.: 18/114,192

(22) Filed: Feb. 24, 2023

Related U.S. Application Data
(60) Provisional application No. 63/430,267, filed on Dec. 5, 2022.
(60) Provisional application No. 63/313,474, filed on Feb. 24, 2022.

(51) Int. Cl. H04L 12/28; H04L 41/0663

(52) U.S. Cl. CPC H04L 12/2801; H04L 41/0663

(57) ABSTRACT

Systems and methods for maintaining keep-alive processes operational during a hardware and/or software fault condition that interrupts normal traffic exchanged with a subscriber. Preferred systems and methods include at least one processor that isolates keep-alive processes from the normal traffic processes.

### CROSS REFERENCE TO RELATED APPLICATIONS

The present application claims priority to U.S. Provisional Application No. 63/430,267 filed Dec. 5, 2022, and U.S. Provisional Application No. 63/313,474 filed Feb. 24, 2022, the contents of which are each incorporated herein by reference in their entirety.

### BACKGROUND

The subject matter of this application relates to sparing systems that provide redundant hardware used to maintain system operation in the event of a fault.

In many different processing environments—e.g., communications networks that involve network elements such as routers or Cable Modem Termination Systems (CMTSs)—there is always the unfortunate possibility of hardware and/or software failures that force an active device to be taken out of service for a window of time. To redress such occurrences, a “sparing” architecture may be employed in which one or more redundant, normally unused devices are available on stand-by in case of a fault in another, normally used device.

Frequently, however, switching operations from the failed sub-system to the spare sub-system can require an undesirable transition period before the spare sub-system can fully assume the responsibility of fully substituting for the failed sub-system. Moreover, there is a trend to reduce the size (footprint) of electrical equipment in many markets, making efficient sparing solutions more difficult or more expensive.

What is desired, therefore, are improves systems and methods for providing network or other equipment with redundancy in the case of component failure.

### BRIEF DESCRIPTION OF THE DRAWINGS

For a better understanding of the invention, and to show how the same may be carried into effect, reference will now be made, by way of example, to the accompanying drawings, in which:

FIGS. 1 and 2 show an exemplary prior art sparing solution.

FIG. 3 shows an exemplary embodiment of a sparing solution where each active and redundant component includes separate processors for normal traffic and keep-alive activities.

FIG. 4 shows an exemplary embodiment of an N+1 sparing solution where each active component and a redundant component includes one processor for both normal traffic and keep-alive activities.

FIG. 5 shows an exemplary embodiment of an N+0 solution where each active component includes separate processors for normal traffic and keep-alive activities.

FIG. 6 shows an exemplary embodiment of an N+0 solution where each active component includes one processor for both normal traffic and keep-alive activities.

### DETAILED DESCRIPTION

As noted above, in many different processing environments there is always the unfortunate possibility of a hardware or software failure that forces the active system to be taken out of service for a window of time. The hardware failures causing these undesirable effects can potentially result from many different effects. These hardware failures can include two types. Failures of the first type are repairable hardware failures such as memory single event upsets that generate soft errors in which the memory contents are randomly changed by the arrival of ionizing particles. These can often be fixed by re-booting the system and starting over with a clean memory. Failures of the second type include hardware failures such as those resulting from an aging component, or incorrect performance due to high ambient temperatures from a fan failure. If the conditions persist, these problems cannot usually be fixed with a simple re-booting of the system, but requires replacement of failed components.

In addition to hardware failures, software failures causing downtime can result from memory leaks that consume all of the available memory, or programming logic errors that (due to recent external inputs) place the software into an undesirable state that makes it unable to perform correctly. Other causes are also possible. Interestingly, for many real-world systems, these “software bug” failures may occur more frequently than the hardware failures described above.

For networking equipment systems that require high availability, rapid resolution of these hardware and/or software failure problems is required. In many cases, this need for high availability can require the addition of some form of redundancy to provide a spare set of circuitry to temporarily or permanently take over for the failed hardware or software sub-system whenever a failure is detected. The subsystems that are typically spared can include MAC layer interface circuit boards and PHY layer interface circuit boards within the networking equipment that connect to other equipment. They can also include management circuit boards within the networking equipment.

Sparing ratios can be designed with 1+1 sparing (where there is a spare sub-system for each active subsystem) or N+1 sparing where there is a single spare subsystem that is shared (in some way) by a group of N active subsystems. It should be noted that 1+1 sparing arrangements can be quite expensive because the cost of the system is roughly doubled. The use of an N+1 sparing arrangement is therefore usually preferred because the additional cost of the single spare subsystem can be shared and amortized across the other N active subsystems, so the multiplier in the cost is roughly given by (N+1)/N=1+(1/N). If N is made to be large (meaning that many active subsystems are sharing the spare subsystem), then the incremental cost (1/N) can be made to be quite small. For example, if N=1 (implying a 1+1 sparing scenario), the cost multiplier of adding another subsystem for sparing is 2.0, hence the cost increases by 100%. If N=5 in an N+1 sparing scenario , then the cost multiplier of adding another subsystem for sparing is 1.2, hence the cost increases by only 20%. If N=10 in an N+1 sparing scenario, the cost multiplier of adding another subsystem for sparing is 1.1, hence the cost increases by only 10%. Large N values can clearly help reduce the percentage cost increase of the added sparing subsystem.

The spare subsystem may take over for the failed subsystem for a short period of time during which the failed subsystem undergoes diagnostics; the failed subsystem is then often power-cycled to reset components and then re-booted (if it appears that the failure was a transient event not likely to be repeated). Management of the service can then be returned to the failed (but now restored) subsystem via a “fail-back” process.

Alternatively, the spare subsystem may take over for the failed subsystem for a long period of time, and even when the originally-failed subsystem is restored to proper operation, service may continue on the spare subsystem (rather than go through the complexities of a “fail-back” process that moves service back to the originally-failed sub-system). In that instance, the original subsystem that failed may become a spare subsystem that backs up the remaining operating subsystems.

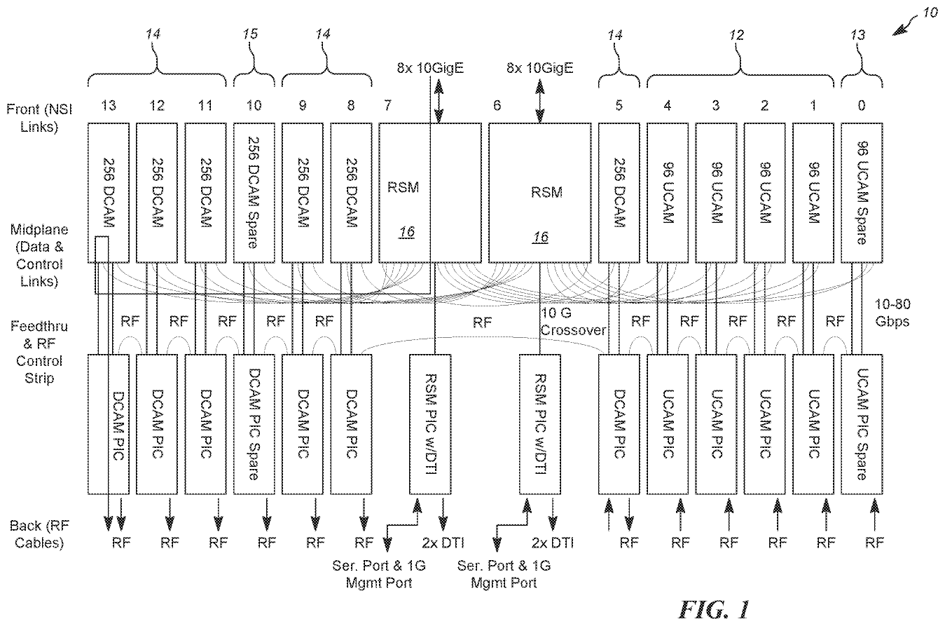

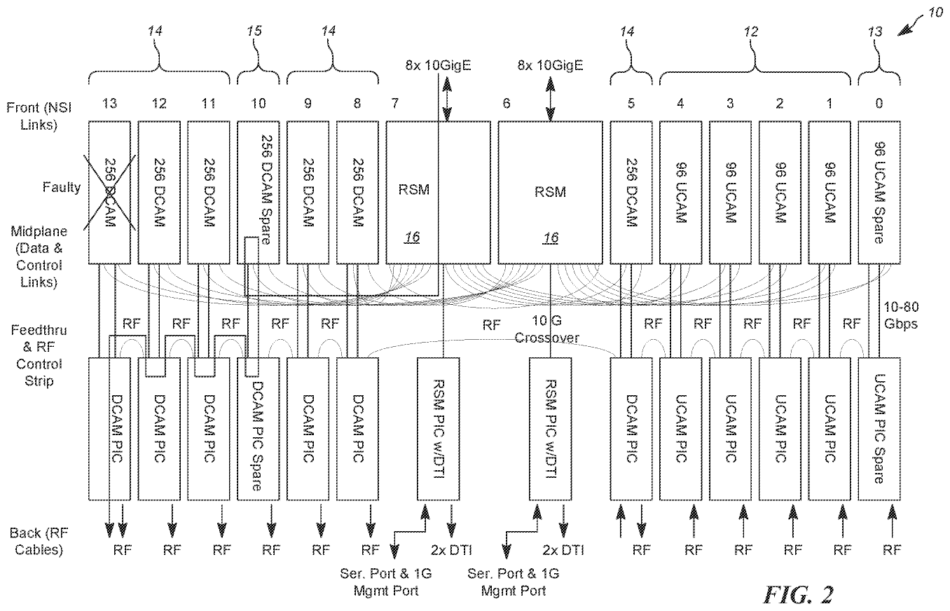

As an example, FIGS. 1 and 2 illustrate how N+1 sparing can be achieved in a Cable Modem Termination System (CMTS). Specifically, a system may comprise an exemplary Converged Cable Access Platform (CCAP) 10 used to illustrate the benefits of the devices, methods, and architectures disclosed in the present specification, although those of ordinary skill in the art will appreciate that these devices, methods and architectures may be employed in any system that includes sparing components to protect against failure. In the system 10, the CCAP 10 may comprise a plurality of active Upstream Cable Access Modules (UCAMs) 12 and a plurality of active Downstream Cable Access Modules (DCAMs) 14, along with a plurality of Router System Modules (RSMs) 16. In both the upstream and downstream direction an N+1 sparing solution is employed by including a spare UCAM 13 and a spare DCAM 15. Specifically, in the upstream direction there are four active UCAMs 12, each backed up by a single spare UCAM 13, while in the downstream direction there are six active DCAMs 14, each backed up by a single spare DCAM 15. FIG. 1 shows the CCAP 10 during normal operation when all active units are operating normally, while FIG. 2 shows an instance when DCAM 13 has a fault, after which the responsibilities of that faulty unit are assumed by the spare DCAM unit 15.

These sparing solutions worked well in the past. However, there are two potential problems with the above sparing solutions. The first problem (Problem #1) stems from the fact that switching from the failed subsystem to the spare subsystem can require an undesirable window of transition time before the spare subsystem can fully take over the responsibilities of operating in place of the failed subsystem. This undesirable transition delay may result from databases and memories within the spare subsystem being correctly loaded with the appropriate data from the failed subsystem. Alternatively, the transition delay may result from the necessity to properly boot some of the processors or chipsets within the spare subsystem. In either event, there may be a short, undesirable window of time when subscribers or users of the original failed subsystem are not receiving service.

In many cases, this transition period will result in a window of service interruption. To better understand this, it is beneficial to differentiate between “normal traffic connections” between the network elements and the subscribers/user and “keep-alive connections” between the network elements and the subscribers/users. Normal traffic connections carry information such as user traffic (IP Video, Web-browsing packet streams, etc.). Keep-alive connections carry unique information that is required to keep the normal traffic connections alive. If keep-alive connections are lost, there is typically a time-consuming set of protocol exchanges that must take place before the keep-alive connections (and the normal traffic connections) can be restored. Thus, there is good reason to maintain keep-alive connections even if the normal traffic connections are temporarily disabled due to sparing events.

Keep-alive connection maintenance is therefore a critical function that must be maintained if possible. There are many different types of keep-alive connections used by different forms of network elements. These can include “heart-beat protocol exchanges” that keep the subscribers and users up and running. Examples of heart-beat protocol exchanges can be diagnostic messages sent between the system and the users. For example, in Cable's DOCSIS systems, a Station Maintenance message must be sent from the CMTS to the cable modem approximately once every 28 seconds. This message is used to trigger a return message called a Range Reply message that helps the CMTS determine if the Cable Modem is still transmitting with proper power levels, proper frequency settings, and proper timing settings. If not, then the CMTS will instruct the cable modem to properly adjust any misaligned settings.

Without this message exchange, the cable modem will rapidly go offline, requiring it to go through the long process of re-ranging and re-registering to get back on line again. Having this disconnect problem occur for many cable modems at the same time (as might occur with the short window of transition described above) will cause a “ranging storm”, which can overload the processors that process these ranging and registration events. This would result in even longer periods of outage being experienced by the users. As a result, this disconnect problem resulting from the short window of transition during a sparing event is truly problematic.

The second problem (Problem #2) arises from recent trends in equipment manufacturing that may make it more difficult to blindly apply the sparing methods described above. In particular, there is a trend to reduce the size of many systems in many markets. This trend may be driven by a need to save rack space in data centers or headends (for cable) or central offices (for telco). This trend may also be driven by a global push to disaggregate the “big-iron box” functionality from single central locations and distribute the network functionality across many locations, with some placed at the single central location and some placed at edge processing locations positioned closer to the subscriber or point of usage.

One of the undesirable results of this trend is that there can oftentimes be fewer subsystems (e.g., circuit boards) positioned together at a single location, making it more difficult to create N+1 sparing solutions. This result can have a very large impact on the costs associated with high-availability-based N+1 sparing approaches. In effect, it eliminates the possibility of setting N to a large number in the N+1 sparing cost calculations outlined above. For example, if there are X sub-systems sitting in a particular location to share the resources of the spare sub-system at that location and if X is a small number, then the N+1 sparing solution will (by definition) be limited to having only X active subsystems sharing the resources of the single spare subsystem. As a result of having N=X being a small number, the cost of the N+1 sparing solution (which was shown above to have a cost multiplier of 1+(1/N)) will be quite high, because the (1/N) term which is equal to (1/X) will be large if X is small. If X is too small, then it may not be cost-effective to add the sparing subsystem to the overall system.

It is clear that each of the aforementioned problems needs a solution. The present specification discloses embodiments that address each such problem. Based on the nature of these problems, it becomes clear that there may be a benefit in separating out the processing of the keep-alive protocols from the processing of normal traffic. Once the keep-alive protocol processing is separated out, the designers can force it to be processed by a separate processor or in a separate process (or group of processes) from the other functions performed in the system.

This separate processor or separate process (for keep-alive functions) would preferably be protected from the functionality-stopping operations related to sparing and re-loading of databases and re-booting; these separated keep-alive functions should therefore preferably continue to function even while sparing transitions are taking place. In addition, the path between these separated keep-alive processes running on the failed subsystem and the subscribers/users should preferably be maintained during all of these sparing operations. Two types of embodiments are disclosed in this specification for which keep alive processes may be maintained while normal activity processes are transferred to a redundant subsystem.

CASE A—Isolated Keep-Alive Protocol Processor

In this first embodiment, the keep-alive protocol processing is preferably moved into a separate processor on the failed subsystem (the separate processor dedicated to heart-beat processing could called, for example, the keep-alive protocol processor). In this embodiment, the remainder of the normal traffic functionality on the failed sub-system can be diagnosed or rebooted without affecting the operations of the keep-alive Protocol Processor, and the keep-alive protocol processor can continue to service the subscribers and users while those diagnostic and rebooting efforts are taking place and while the spare subsystem is having its databases loaded or processors/chipsets booted . Once a stable platform becomes available to take over the other normal traffic functions (either in the spare subsystem or in the newly-restored, failed subsystem), then those normal traffic functions can be re-initiated on either the spare subsystem or on the original failed (but now restored) subsystem. However, while all of those transitions are taking place, the keep-alive protocol processor would keep the subscribers and users connected to the system so that the subscriber and user elements did not require total reboots themselves. Those of ordinary skill in the art will appreciate that, if the spare subsystem became the new stable platform providing operations, then the keep-alive protocol processor on the spare subsystem can take over for the keep-alive protocol processor on the failed subsystem once it is ready to do so. At that point in time, the entire keep-alive protocol processor on the failed subsystem can be power-cycled for rebooting purposes since its involvement in the protocol functionality is no longer needed, and in some embodiments the original failed subsystem, but now rebooted subsystem, may potentially become a spare subsystem, assuming that rebooting restored all functionality on that subsystem.

CASE B—Isolated Keep-Alive Protocol Process(es) on Processor

If there is only one processor on each subsystem, then a solution would be required to attempt the same benefits by splitting the functions into separate processes on that processor. If the keep-alive protocol processing was placed entirely within a separate process (or a separate set of processes) on the single processor within the network element's subsystem, then that separate process (or separate set of processes) dedicated to keep-alive protocol processing could be called (for example) the keep-alive protocol process (or the keep-alive protocol processes). The rest of the processes associated with normal traffic functionality would then be placed within a different process that might be called the normal traffic process. If a software fault or single event upset fault were to occur within that normal traffic process, then that particular process could be diagnosed and/or halted and rebooted (on the present processor or on a different processor within a spare sub-system) without affecting the operations of the keep-alive protocol process (or processes). As a result, the keep-alive protocol process (or processes) could continue to service the keep-alive connections to the subscribers and users while those diagnostic and rebooting efforts are taking place on the network traffic processes (on the present processor or on a different processor within a spare subsystem). Once the normal traffic process is stabilized (via a reboot or some other action on the present processor or on a different processor within a spare subsystem) and becomes available to re-enable the normal traffic functions, then those network traffic functions can be re-initiated. However, while all of those transitions were taking place, the keep-alive protocol process (or processes) was keeping the keep-alive connections to subscribers and users active so that the subscriber and user elements did not require total reboots themselves. It should be noted, as above with respect to Case A, that if the normal traffic functions were re-established on a different processor with a spare subsystem, then the keep-alive process on that spare subsystem's processor can take over the functionality for the keep-alive process running on the initial processor. Thus, the use of a separate process for the keep-alive protocol processing can greatly reduce the downtime for subscribers/users by keeping the subscribers/users connected to the keep-alive connections.

For the Disconnect Problem, a technique is desirable to, at a minimum, keep the subscribers and users connected to the system for any heart-beat protocol exchanges (keep-alive messages, diagnostic messages, Station Maintenance messages, etc.) while the transition operations or re-booting operations are taking place.

Clearly, using either a Case A or Case B solution, the heartbeat protocols or keep-alive messages can be continually maintained between the failed subsystem and the subscribers/users, as long as the processor on which the heart-beat processes are running continues to run and as long as the path between the processor on which the heart-beat processes are running and the subscribers/users is kept operational. The heart-beat protocols should therefore be able to keep the processes at the subscriber/user sites operational until the newly-launched functions on the spare subsystem, or the newly-launched functions on a re-booted originally-failed subsystem, have come on line. As a result, the subscribers/users should not need to re-range and re-register. In essence, the above Case A or Case B solutions help to resolve the aforementioned Disconnect Problem (Problem #1).

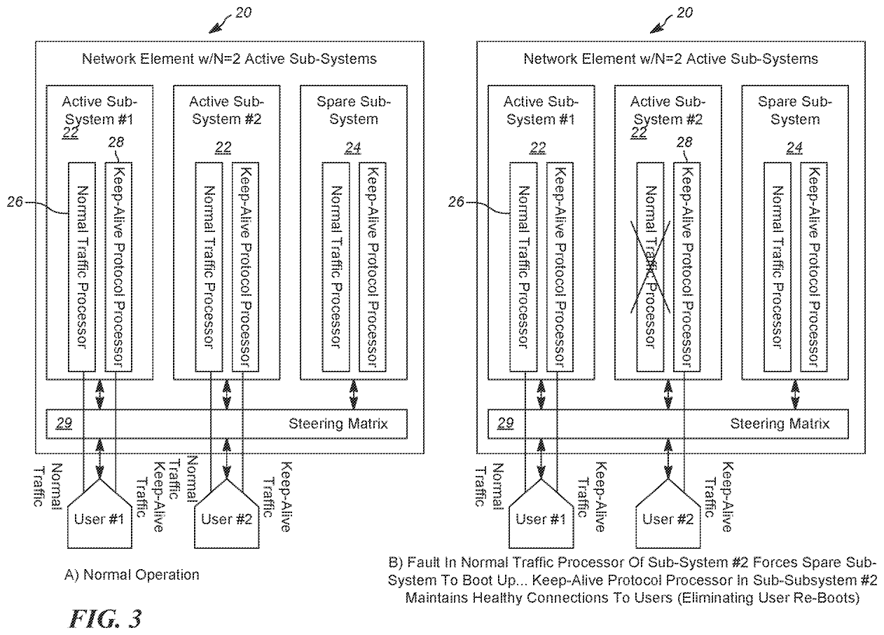

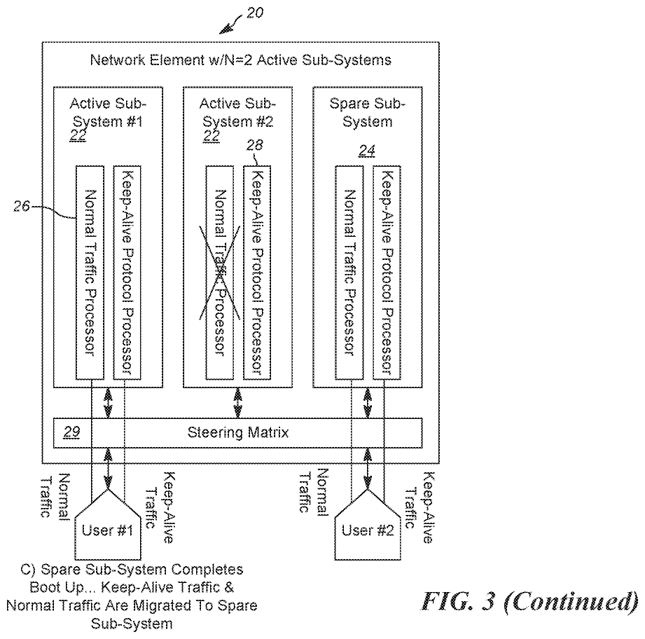

FIG. 3 shows the separation of functions and the placement of functions at various points in time for the Case A scenario dealing with Problem #1. In particular, FIG. 3 illustrates how to ensure that keep-alive traffic remains flowing even when sparing operations switch normal traffic from the failed subsystem to a spare subsystem and create a window of no normal traffic connectivity. Specifically, FIG. 3 shows an exemplary CCAP 20 having an N+1 architecture with two active subsystems 22, each serving a respectively different user (i.e., user #1 and user #2) or respectively different groups of users. Each of the CCAPs 20 also has a redundant (or spare) subsystem 24. Each active subsystem 22 and spare subsystem 22 comprises a first processor 26 for normal traffic and a second processor 28 for keep-alive activities.

In FIG. 3, a redundant subsystem 24 is available to pick up the normal traffic service, but that the transition from the failed subsystem to the redundant subsystem consumes a window of time that would ordinarily be damaging to the operation of the keep-alive protocols, but for the separation of the normal traffic processes from the keep alive activities processes using, e.g. the separate processors 26 and 28. Specifically, a normal operation is shown in panel (a) of FIG. 3 where both active subsystems 22 are operational. In this situation, the normal traffic processes performed by the first processor 26 and the keep-alive activities of the second processor 28, in each active subsystem, are routed by a steering network 29 to/from the user respectively served by each active subsystem. However, when a fault occurs in the normal traffic processes of one of the active subsystems 22—as is depicted in panel (b) of FIG. 3—the second processor 28 of that active subsystem, which implements the keep-alive activities, continues to function and the steering network 29 continues to route the keep-alive activities of that faulty subsystem to/from the respectively served user while the spare subsystem 24 boots up. When the spare subsystem has fully booted, as seen in panel (c) of FIG. 3, the steering network 29 redirects the processing flows of both the normal traffic processes and the keep-alive activities previously served by the faulty active subsystem 22 to instead be served by the first processor 26 and the second processor 28 of the spare subsystem 24. To facilitate the operation described above, in some embodiments, the keep-alive processor 28 may preferably be connected to the steering network 29 via a path that is independent from that by which the normal traffic processor 26 is connected to those subscribers.

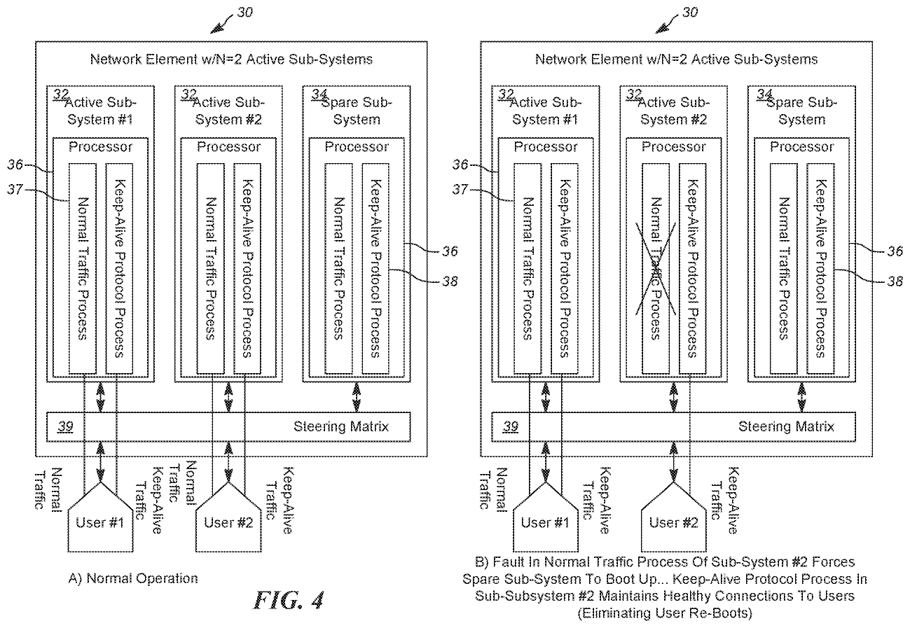

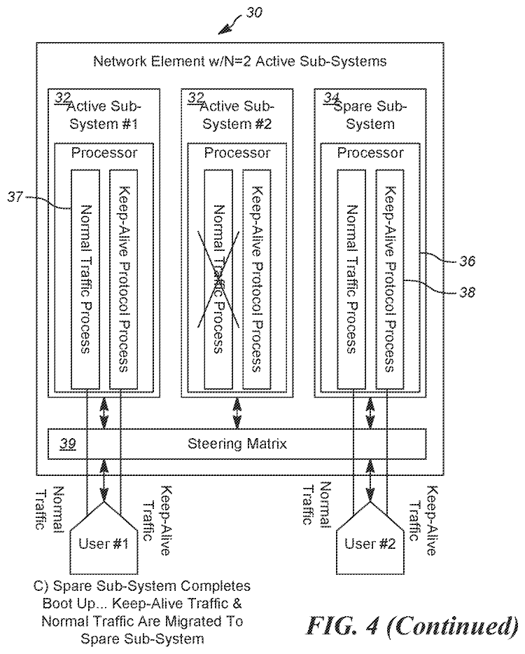

FIG. 4 shows an alternate embodiment, which addresses the Case B scenario dealing with Problem #1, i.e. an embodiment in which each active subsystem as well as the spare subsystem utilize a single processor that performs both the normal traffic processes and keep-alive activities. In particular, this figure illustrates how to ensure that keep-alive traffic remains flowing even when sparing operations switch normal traffic from a failed subsystem to a spare subsystem and create a window of no normal traffic connectivity. Specifically, FIG. 4 shows an exemplary CCAP 30 having an N+1 architecture with two active subsystems 32, each serving a respectively different user (i.e., user #1 and user #2) or respectively different groups of users. Each of the CCAPs 30 also has a redundant (or spare) subsystem 34. Each active subsystem 32 and spare subsystem 32 comprises a processor 36 that includes a first subsystem 37 for Normal Traffic processes and a second subsystem 38 for keep-alive activities processes. The first subsystem 37 and the second subsystem 38 are isolated from each other (e.g., using different cores) such that termination of processes in the first subsystem does not require or cause termination of processes in the second subsystem.

In these figures, it is assumed that there is a redundant subsystem available to pick up the normal traffic service, but that the transition from the failed subsystem to the redundant subsystem consumes a window of time that would be damaging to the operation of the keep-alive protocols, but for the separation of the normal traffic processes from the keep-alive activities processes using, e.g. the separate processes 37 and 38. Specifically, a normal operation is shown in panel (a) of FIG. 3 where both active subsystems 32 are operational. In this situation, the Normal Traffic processes performed by the first process 37 and the keep-alive activities of the second process 38, in each active subsystem, are routed by a steering network 39 to/from the user respectively served by each active subsystem. However, when a fault occurs in the normal traffic processes of one of the active subsystems 32—as is depicted in panel (b) of FIG. 3—the second process 38 of that active subsystem, which implements the keep-alive activities, continues to function and the steering network 39 continues to route the keep-alive activities of that faulty subsystem to/from the respectively served user while the spare subsystem 34 boots up. When the spare system has fully booted, as seen in panel (c) of FIG. 3, the steering network 39 redirects the processing flows of both the normal traffic processes and the keep-alive activities previously served by the faulty active subsystem 32 to instead be served by the first process 37 and the second process 38 of the processor 36 in the spare subsystem 24. To facilitate the operation described above, the keep-alive processes 38 is may in some embodiments be routed to the steering network 39 via a path that is independent from that by which the normal traffic processes 37 are connected to those subscribers.

Now consider the second problem described above. In the trending distributed architectures that are currently being proposed in both the Wireless industry and the Cable industry, the number of active subsystems sharing a chassis tends to be quite small. For example, sometimes there is only one active subsystem (as is the case for Distributed Access Architecture Remote PHY Nodes or Distributed Access Architecture Remote MACPHY Nodes in the Cable Industry). In these cases, N=1, and the cost of adding redundancy is very high (leading to a doubling of the cost with the addition of a second spare subsystem within the node, as described above for N=1). This same problem is found in many of the smaller shelf-based solutions that may include only a few active subsystems, where N is still quite small (<10).

Given these constraints within many of the distributed systems, it may arguably be the case that redundant subsystems for sparing and high-availability applications are never added. This presents a conundrum, because although the number (N) of active subsystems in these distributed systems may be quite small, there still is a desire by operators to have some level of redundancy, yet redundancy using a spare subsystem is cost-prohibitive.

This specification describes the use of a “poor-man's” solution to the problem in which there is no redundant subsystem for any of the circuitry on the subsystem. This “poor-man's” solution unfortunately does not address the problems associated with long-term hardware faults (such as equipment or component failures), but it does address the problems associated with transient hardware faults (such as single-event upsets) and it also addresses the problems associated with software faults. Thus, since the probability of software faults oftentimes tends to be higher than the probability of hardware faults, and since this “poor-man's” solution covers both software faults and transient hardware faults, it may be a solution that provides some real benefits.

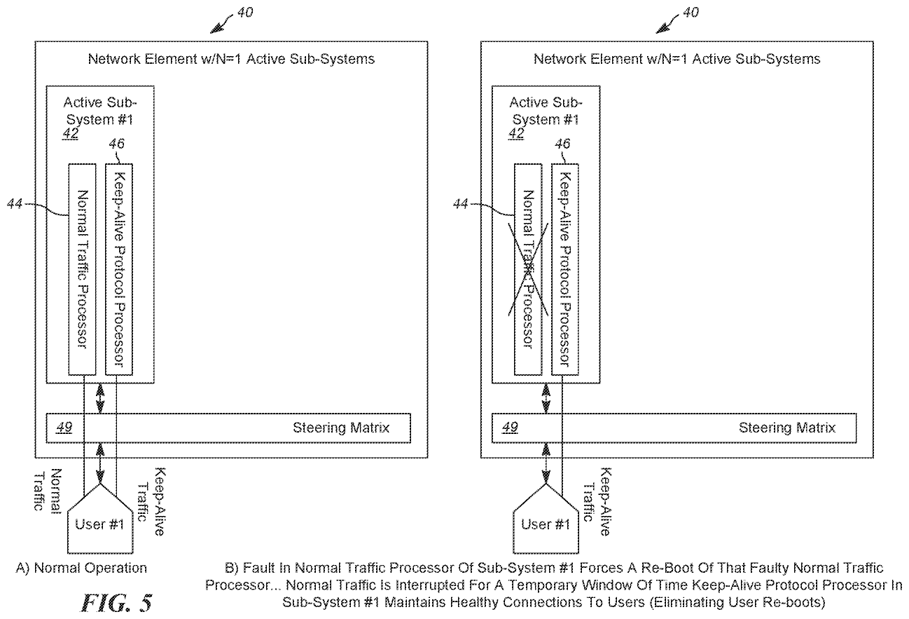

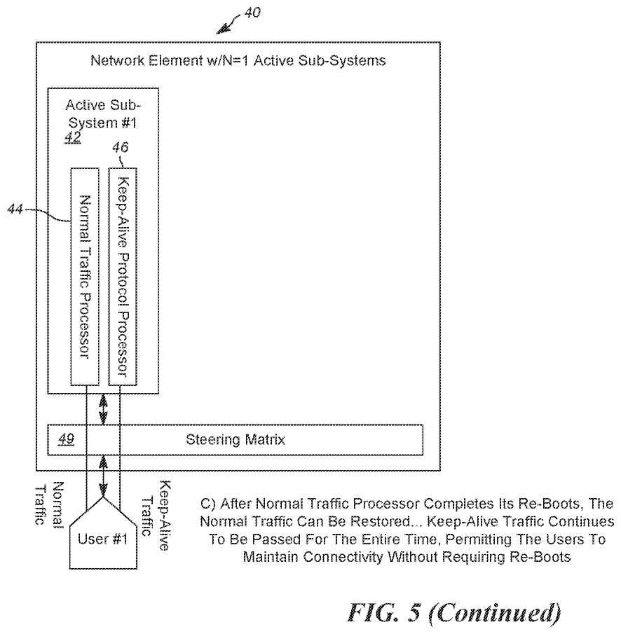

FIG. 5 shows an exemplary CCAP 40 having a single active subsystem 42. The active subsystem 42 in turn has a first processor 44 for normal traffic and a separate processor 46 for keep-alive processes or protocols. The CCAP 40 as shown in this figure addresses the Case A scenario dealing with Problem #2, i.e. ensuring that keep-alive traffic remains flowing even when the processor associated with normal traffic is reset on the failed subsystem. Specifically, the normal traffic processes performed by the first processor 44 and the keep-alive activities of the second processor 46 are individually routed by a steering network 49 to/from the user respectively served by each separate processor. However, when a fault occurs in the normal traffic processes of the processor 4413 as is depicted in panel (b) of FIG. 5—the second processor 46, which implements the keep-alive activities, continues to function and the steering network 49 continues to route the keep-alive activities to/from the respectively served user(s) while the processor 44 reboots. When the processor 44 has fully booted, as seen in panel (c) of FIG. 5, the steering network 49 directs the processing flows of both the normal traffic processes and the keep-alive activities to the user(s). To facilitate the operation described above, in some embodiments, the keep-alive processor 46 may preferably be connected to the steering network 49 via a path that is independent from that by which the normal traffic processor 44 is connected to those subscribers.

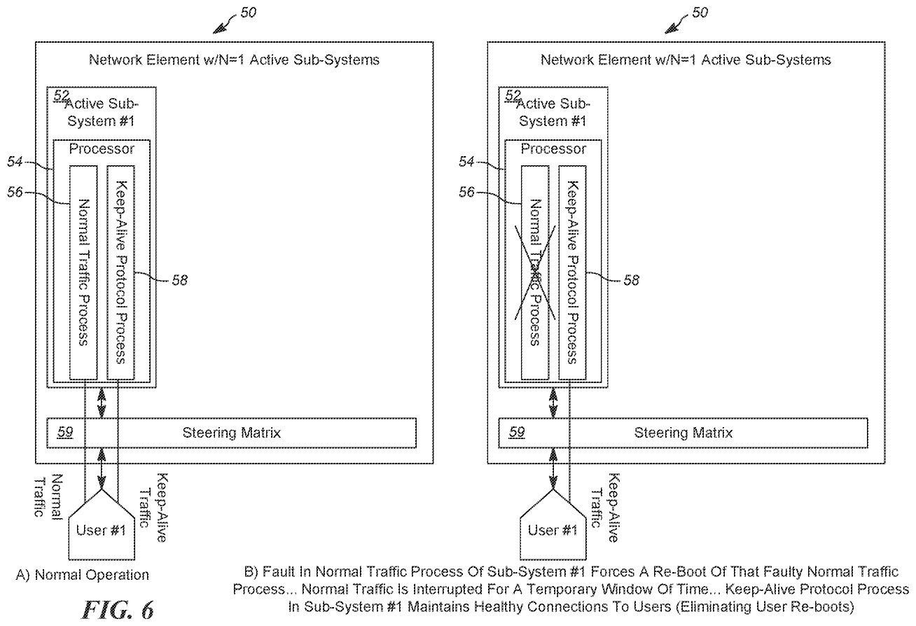

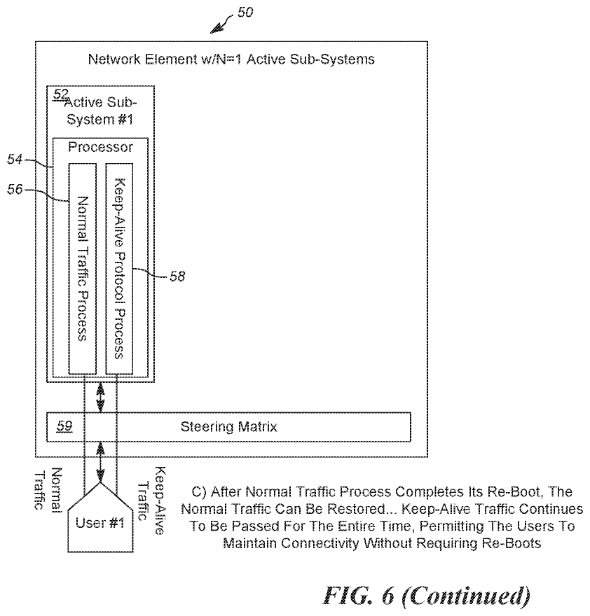

FIG. 6 shows an exemplary “poor-man's” solution at various points in time utilizing a single processor having separate processes, isolated from each other, for normal traffic and keep-alive activities, respectively. The depicted CCAP 50 addresses the Case B scenario dealing with Problem #2 i.e., ensuring the flow of keep-alive traffic even when a single processor 54 on single active subsystem 52 that performs both normal traffic operations and keep-alive activities experiences a failure in the normal traffic processes. It achieves this by including a separate process 58 (or separate set of processes) for the keep-alive activities that are isolated from the normal traffic processes 56. Preferably, the normal traffic processes 56 performed by the processor 54 and the keep-alive activities 58 of the processor 54 are individually routed by a steering network 59 to/from the user respectively served by each process 56, 58. Thus, when a fault occurs in the normal traffic processes 56 of the processor 54—as is depicted in panel (b) of FIG. 6—the second process(es) 58, which implements the keep-alive activities, continues to function and the steering network 59 continues to route the keep-alive activities to/from the respectively served user(s) while the process or processes 56 reboots. When this occurs, as seen in panel (c) of FIG. 6, the steering network 59 directs the processing flows of both the normal traffic processes and the keep-alive activities to the user(s). To facilitate the operation described above, in some embodiments, the keep-alive processes 58 may preferably be connected to the steering network 59 via a path that is independent from that by which the normal traffic processes 56 is connected to those subscribers.

This specification discloses embodiments that separates and isolates keep-alive processing functions from other normal traffic functions in a network element or processing system, such as a CCAP, CMTS, etc. This separation and isolation can be accomplished by placing the different functions onto different physical processors (Case A); or the separation and isolation can be accomplished by placing the different functions into different processes within a single processor (Case B). The resulting performance improvements are similar for both Case A & Case B scenarios.

Once these functions are separated and isolated, the resulting design permits the system to maintain connectivity and proper operation for the keep-alive connections between the applicable network element or processing system and the subscribers/users who require continuity on the keep-alive connections. As a result, disruptive operations such as sparing operations can be implemented on the normal traffic functions without disrupting the keep-alive connections. The disruptive operations would typically cause a temporary halt to the normal traffic flow functions, but not to the keep-alive functions. Since disruption of keep-alive connections can lead to time-consuming protocol exchanges for re-establishment of those keep-alive connections, this approach helps to reduce any total outage times associated with the disruptive activities on the normal traffic functions. The total outage time is limited to be only the outage time on the normal traffic flows and does not have any subsequent outage times added in due to any required re-establishment of keep-alive connections. Thus, the total outage time can be greatly reduced.

| | Separation Between | Normal Traffic | |
|---|---|---|---|
| | Normal Traffic functions | Outage | Keep-Alive Traffic |
| # Sub-Systems | & Keep-Alive functions | Time | Outage Time |
| N + 1 (With | No Separation (both | Can be short . . . only | Can be short . . . only |
| N Active | functions handled by | requires steering Normal | requires steering Keep- |
| Sub-systems | single process on single | Traffic to initialized | Alive Traffic to |
| & 1 Spare | processor) | Spare Sub-system after | initialized Spare Sub- |
| Sub-system) | | the Spare Sub-system is | System is initialized . . . |
| | | initialized | but can be disruptive to |
| | | | some subs whose timers |
| | | | timed out during the |
| | | | short outage & needed |
| | | | re-establishing of Keep- |
| | | | Alive sessions |
| N + 1 (With | Case A (separation into | Can be short . . . only | Can be practically non- |
| N Active | different processors) | requires steering Normal | existent . . . few |
| Sub-systems | | Traffic to initialized | disruptions to subs since |
| & 1 Spare | | Spare Sub-system after | Keep-Alive is kept up in |
| Sub-system) | | the Spare Sub-system is | separated processor & |
| | | initialized | transferred smoothly |
| | | | from Failed to Spare |
| | | | Sub-system |
| N + 1 (With | Case B (separation into | Can be short . . . only | Can be practically non- |
| N Active | different processes on a | requires steering Normal | existent . . . few |
| Sub-systems | single processor) | Traffic to initialized | disruptions to subs since |
| & 1 Spare | | Spare Sub-system after | Keep-Alive is kept up in |
| Sub-system) | | the Spare Sub-system is | separated process & |
| | | initialized | transferred smoothly |
| | | | from Failed to Spare |
| | | | Sub-system |
| 1 (No Sparing) | No Separation (both | Can be extremely long . . . | Can be lengthy . . . |
| | functions handled by | requires entire re-boot of | requires entire re-boot of |
| | single process on single | Normal Traffic functions | Normal Traffic functions |
| | processor) | & keep alive functions . . . | & Keep-Alive |
| | | requires re-establishing | functions . . . requires re- |
| | | of Keep-Alive sessions | establishing of Keep- |
| | | | Alive sessions |
| 1 (No Sparing) | Case A (separation into | Can be moderately | Can be practically non- |
| | different processors) | long ... requires entire re- | existent . . . few |
| | | boot of Normal Traffic | disruptions to subs since |
| | | functions (but not Keep- | Keep-Alive is kept up in |
| | | Alive functions . . . and | separated processor |
| | | requires no re- | while Normal Traffic |
| | | establishing of Keep- | functions are re-booted |
| | | Alive sessions | |
| 1 (No Sparing) | Case B (separation into | Can be moderately | Can be practically non- |
| | different processes on a | long . . . requires entire re- | existent . . . few |
| | single processor) | boot of Normal Traffic | disruptions to subs since |
| | | functions (but not Keep- | Keep-Alive is kept up in |
| | | Alive functions . . . and | separated process while |
| | | requires no re- | Normal Traffic functions |
| | | establishing of Keep- | re re-booted |
| | | Alive sessions) | |

Depending on the particular scenario being considered, different attributes and improvements can be realized (as shown in the table above).

It will be appreciated that the invention is not restricted to the particular embodiment that has been described, and that variations may be made therein without departing from the scope of the invention as defined in the appended claims, as interpreted in accordance with principles of prevailing law, including the doctrine of equivalents or any other principle that enlarges the enforceable scope of a claim beyond its literal scope. Unless the context indicates otherwise, a reference in a claim to the number of instances of an element, be it a reference to one instance or more than one instance, requires at least the stated number of instances of the element but is not intended to exclude from the scope of the claim a structure or method having more instances of that element than stated. The word “comprise” or a derivative thereof, when used in a claim, is used in a nonexclusive sense that is not intended to exclude the presence of other elements or steps in a claimed structure or method.

1. A device comprising:
at least one processor performing a first set of processes for exchanging traffic with a user and a second set processes comprising keep-alive traffic required to maintain the exchange of the first set of processes, where the second set of processes is isolated from the first set of processes.

2. The device of claim 1 comprising a Converged Cable Access Platform (CCAP).

3. The device of claim 1 where the first set of processes and the second set of processes are performed on respectively different processors.

4. The device of claim 3 having an output selectively connectable to a transmission medium to at least one subscriber, and including a steering network interposed between the output and the respectively different processors.

5. The device of claim 4 where each processor is connected to the steering network via a path independent of that of the other processor.

6. The device of claim 1 where the first set of processes and the second set of processes are performed on a single processor.

7. The device of claim 6 having an output selectively connectable to a transmission medium to at least one subscriber, and including a steering network interposed between the output and the processor.

8. The device of claim 7 where each process is connected to the steering network via a path independent of that of the other process.

9. The device of claim 1 configured to selectively steer the first set of processes to another device during a failure in the at least one active processor.

10. The device of claim 1 configured to maintain the keep-alive traffic while the at least one active processor performs a reboot of the first set of processes.

11. A method performed on at least active processor performing a first set of processes for exchanging traffic with a user and a second set processes comprising keep-alive traffic required to maintain the exchange of the first set of processes, the method comprising:
detecting a failure of the first set of processes; and
performing a reboot of the first set of processes while the processor continues to perform the second set of processes.

12. The method of claim 11 performed in a Converged Cable Access Platform (CCAP).

13. The method of claim 11 where the first set of processes and the second set of processes are performed on respectively different processors.

14. The method of claim 13 including outputting at least one of the first set of processes and the second set of processes to a transmission medium to at least one subscriber, and through a steering network interposed between the output and the respectively different processors.

15. The method of claim 14 where each processor is connected to the steering network via a path independent of that of the other processor.

16. The method of claim 11 where the first set of processes and the second set of processes are performed on a single processor.

17. The method of claim 16 including outputting at least one of the first set of processes and the second set of processes to a transmission medium to at least one subscriber, and through a steering network interposed between the output and the respectively different processes.

18. The method of claim 17 where each process is connected to the steering network via a path independent of that of the other process.

19. The method of claim 11 configured to selectively steer the first set of processes to another device during a failure in the at least one active processor.
